(19) United States
(12) Patent Application Publication
(10) Pub. No.: US 2017/0054554 A1
(43) Pub. Date: Feb. 23, 2017

(54) APPARATUS FOR OBFUSCATING AND RESTORING PROGRAM EXECUTION CODE AND METHOD THEREOF

(71) Applicant: HYUNDAI AUTOEVER CORP., Seoul (KR)

(72) Inventor: SOO HYUN PARK, Seoul (KR)

(21) Appl. No.: 14/970,441

(22) Filed: Dec. 15, 2015

(30) Foreign Application Priority Data
Aug. 19, 2015 (KR) 10-2015-0116465

(51) Int. Cl. H04L 9/08

(52) U.S. Cl. CPC H04L 9/0819; H04L 9/088

(57) ABSTRACT

The present invention provides an apparatus for obfuscating and restoring a program execution code. The apparatus for restoring an obfuscated program execution code may include a memory loading a program execution code obfuscated so as not to be executed before restoration from a storage medium; a restoring unit, not allowing access by a third party who is not a user of the apparatus, restoring the obfuscated program execution code delivered from the memory and directly delivering it to a central processing unit (CPU); and a CPU executing the restored program execution code. Thus, since the execution code order which shows the same operation as the original program execution cannot be known even by a third party who achieved and analyzed a program execution code executed in a single equipment, it is not possible to analyze the algorithm, etc. through program execution code analysis, and it is not possible to execute the achieved execution code at a different equipment. Accordingly, intellectual property right can be protected.

### CROSS-REFERENCE TO RELATED APPLICATIONS

This application claims priority from Korean Patent Application No. 10-2015-0116465, filed on Aug. 19, 2015, in the Korean Intellectual Property Office. The entire contents of said application are incorporated herein by reference.

### BACKGROUND

1. Technical Field

The present invention relates to an apparatus for obfuscating and restoring a program execution code and a method thereof. More specifically, the present invention relates to obfuscating and restoring a program execution code, so as to protect intellectual property right on program, and defend and detect a third party's code deobfuscation.

2. Background Art

The ownership of a program is recognized by the intellectual property right system. Although the ownership may be used after making an appropriate amount of payment, loss in property incurs due to indiscreet illegal reproduction. That is, infringement of intellectual property right such as program or software such as deriving the algorithm through program execution code analysis and abnormally using the program through illegal reproduction of the program, etc., is gradually increasing.

In order to protect intellectual property right of programs, software companies, etc. developing and selling programs adopt protection techniques such as granting program identification numbers, authenticating online programs, obfuscating program codes, etc. Particularly, code obfuscation is used as a means preventing the figuring out of important information such as algorithm, etc. applied to a program through program code analysis. Code obfuscation uses a method that makes it difficult for a third party to analyze a program code by changing the name of variable or function used by most programs so that it cannot be easily identified, or inserting a useless code, etc. which is not actually used. However, the obfuscation technique only has an effect of making it difficult to analyze the algorithm or logic by a human, and has limitations that analysis on the code cannot be actually restricted. Particularly, for most of the cases, the name of the variable or function, etc. is not used in the actual execution code loaded in the memory. Thus, the technique would be useless when directly analyzing the execution code loaded in the memory. An execution code present as a file may be protected by a method for encrypting an execution code, etc., but in order for the code to be executed by a CPU, etc., the execution code should be decrypted and loaded in the memory, etc. Thus, it would be difficult to protect the execution code when it is possible to access the memory.

### SUMMARY OF INVENTION

In order to overcome the above problems, it is a first object of the present invention to provide an apparatus for obfuscating a program execution code and restoring an obfuscated program execution code, capable of obfuscating software so as not to be executed before restoration, preventing a third party from accessing software restored to achieve minimum information required for execution, and when correcting or accessing hardware in order for a third party to access the software executed, detecting and preventing this.

Also, in order to overcome the above problems, it is a second object of the present invention to provide a method for obfuscating a program execution code and restoring an obfuscated program execution code, capable of obfuscating software so as not to be executed before restoration, preventing a third party from accessing software restored to achieve minimum information required for execution, and when correcting or accessing hardware in order for a third party to access the software executed, detecting and preventing this.

However, the problems to be solved in the present invention are not limited to the above, and may be altered variously within a scope that does not deviate from the idea and scope of the present invention.

In order to solve the above problems, an apparatus for restoring an obfuscated program execution code according to an embodiment of the present invention may include a memory loading a program execution code obfuscated so as not to be executed before restoration from a storage medium; a restoring unit, not allowing access by a third party who is not a user of the apparatus, restoring the obfuscated program execution code delivered from the memory and directly delivering it to a central processing unit (CPU); and a CPU executing the restored program execution code.

According to an embodiment, the apparatus may further include a random number generator generating a unique random number sequence for the apparatus, and the obfuscated program execution code may be a program execution code rearranging the order of executing instructions based on the unique random number sequence for the apparatus, and the restoring unit may be configured to restore the obfuscated program execution code by restoring the order of executing the instructions to its original state based on the unique random number sequence for the apparatus.

According to an embodiment, the CPU may include an instruction cache (I-cache) and a data cache (D-cache), and the restoring unit may be configured to directly deliver the restored program execution code to the I-cache.

According to an embodiment, the random number generator may be configured so as not to generate a unique random number sequence for the apparatus in response to access by a third party other than a user of the apparatus.

According to an embodiment, the apparatus may further include a housing completely surrounding the apparatus, and the random number generator may be configured so as not to generate a unique random number sequence for the apparatus in response to damage to the housing.

According to an embodiment, the random number generator may be physically combined with a joint of the housing and configured to be permanently damaged when the housing is open.

Meanwhile, an apparatus for obfuscating a program execution code according to another embodiment of the present invention may include a receiving unit for receiving an encryption program execution code encrypted based on a public key corresponding to a unique private key of the apparatus; a private key storing unit for storing the unique private key of the apparatus; and an obfuscating unit for decrypting the encryption program execution code based on the unique private key, obfuscating the decrypted program execution code so that it is not executed before restoration, and storing the obfuscated program execution code in a storage medium.

According to an embodiment, the apparatus may further include a random number generator generating a unique random number sequence for the apparatus, and the obfuscating unit may be configured to generate the obfuscated program execution code by rearranging the order of executing instructions of the decrypted program execution code based on the unique random number sequence for the apparatus.

According to an embodiment, the random number generator may be configured so as not to generate a unique random number sequence for the apparatus in response to access by a third party other than a user of the apparatus.

According to an embodiment, the apparatus may further include a housing completely surrounding the apparatus, and the random number generator may be configured so as not to generate a unique random number sequence for the apparatus in response to damage to the housing.

According to an embodiment, the random number generator may be physically combined with a joint of the housing and configured to be permanently damaged when the housing is open.

Meanwhile, a method for restoring an obfuscated program execution code performed by a computing device according to another embodiment of the present invention may include loading a program execution code obfuscated so as not to be executed before restoration from a storage medium to a memory; restoring the obfuscated program execution code right before delivering it to a central processing unit (CPU) so that the restored program execution code is not loaded in the memory; and executing the restored program execution code by using the CPU.

According to an embodiment, the method may further include generating a unique random number sequence for the computing device, and the obfuscated program execution code may be a program execution code rearranging the order of executing instructions based on the unique random number sequence, and the restoring step may restore the obfuscated program execution code by restoring the order of executing the instructions to its original state based on the unique random number sequence.

According to an embodiment, the method may further include interrupting generation of the unique random number sequence in response to access by a third party other than a user of the computing device.

According to an embodiment, the interrupting step may interrupt generation of the unique random number sequence in response to damage to a housing completely surrounding the computing device.

Meanwhile, a method for obfuscating a program execution code performed by a computing device according to another embodiment of the present invention may include receiving an encryption program execution code encrypted based on a public key corresponding to a unique private key of the computing device from a server; decrypting the encryption program execution code based on a unique private key of the computing device; obfuscating the decrypted program execution code so that it is not executed before restoration; and storing the obfuscated program execution code in a storage medium.

According to an embodiment, the method may further include generating a unique random number sequence for the computing device, and the obfuscating step may generate the obfuscated program execution code by rearranging the order of instructions of the decrypted program execution code based on the unique random number sequence.

According to an embodiment, the method may further include interrupting generation of the unique random number sequence in response to access by a third party other than a user of the computing device.

According to an embodiment, the interrupting step may interrupt generation of the unique random number sequence in response to damage to a housing completely surrounding the computing device.

According to an apparatus and method for obfuscating a program execution code and an apparatus and method for restoring an obfuscated program execution code according to an embodiment of the present invention, it would be possible to prevent a third party from accessing software restored to achieve minimum information required for execution, and when correcting or accessing hardware in order for a third party to access the software executed, this may be detected and prevented.

Thus, since the execution code order which shows the same operation as the original program execution cannot be known even by a third party who achieved and analyzed a program execution code executed in a single equipment, it is not possible to analyze the algorithm, etc. through program execution code analysis, and it is not possible to execute the achieved execution code at a different equipment. Accordingly, intellectual property right can be protected.

That is, it would be possible to prevent an algorithm from being revealed through analysis even if a third party achieves a program execution code, or prevent a program execution code achieved at a different equipment from being executed normally. A program execution code may be stored having the execution order mixed up using consecutive random numbers generated by a unique random number generator corresponding to each apparatus, and a third party cannot directly access a unique random number generator. When attempting physical damage for direct access, the corresponding random number generator may not generate the same random number any more. Thus, the execution order of the program execution code may not be restored to its original state and the correct execution order may not be known. Thus, the algorithm may not be derived through execution code analysis, and when the same random number generator is not present, a program execution code obfuscated at a different apparatus may not be executed.

### BRIEF DESCRIPTION OF THE DRAWINGS

FIG. 1 is a conceptual diagram illustrating a system for obfuscating and restoring a program execution code according to an embodiment of the present invention;

FIG. 2 is a block diagram illustrating a constitution of an apparatus for restoring an obfuscated program execution code according to an embodiment of the present invention;

FIG. 3 is a block diagram illustrating a constitution of an apparatus for obfuscating a program execution code according to an embodiment of the present invention;

FIG. 4 is an exemplary diagram illustrating software code obfuscation through an obfuscation platform according to an embodiment of the present invention;

FIG. 5 is a flow chart illustrating a method for restoring an obfuscated program execution code according to an embodiment of the present invention; and

FIG. 6 is a flow chart illustrating a method for obfuscating a program execution code according to an embodiment of the present invention.

### DETAILED DESCRIPTION

### Best Mode for Carrying Out the Invention

Specific structural and functional details disclosed herein are merely representative for purposes of describing example embodiments. The present invention, however, can be embodied in may alternate forms and should not be construed as limited to only the example embodiments set forth herein.

The present invention may be variously changed and may have various embodiments, among which specific embodiments will be exemplified in the accompanying drawings and described below in detail. However, it is not intended to limit the present invention to the specific embodiments, and it shall be appreciated that all the changes, equivalents and substitutions belonging to the idea and technical scope of the present invention are included in the present invention.

As used herein, terms are used merely for describing specific embodiments and are not intended to limit the present invention. The singular terms cover plural components unless it is apparent that the singular terms have different meanings contextually. In this application, terms such as “comprise” or “have,” shall be understood that they are used merely for designating that corresponding features, numbers, steps, actions, components, parts or the combinations thereof may exist, but not excluding in advance the possibility of existence or addition of the features, the numbers, the steps, the actions, the components, the parts or the combinations thereof.

Unless defined otherwise, all the terms including technical or scientific terms used herein have the same meanings as those understood generally by a person having ordinary skill in the art. The terms having the same meanings as those defined in generally used dictionaries shall be construed to have the meanings conforming to the contextual meanings of the related technologies, and shall not be construed as ideal or excessively formal meanings unless the terms are apparently defined in this application.

Hereinafter, embodiments of the present invention will be described in detail with reference to accompanying drawings. The same reference numerals are given to the same components, and repeated explanation will be omitted.

Software Obfuscation

Software obfuscation is an important technique for achieving purposes such as protecting intellectual property right, analyzing and defending vulnerabilities by preventing reverse engineering of various softwares. However, in general computing environment, software obfuscation has technical limitations, which are roughly because of the following two reasons.

A. All softwares are to be properly executed in a specific computing environment, and software obfuscation may be accomplished only within a boundary where the software may be properly executed.

B. At the moment a software is executed at a computing platform, minimum information required for execution must be maintained. For example, when encryption is applied to a software, the software must be decrypted right before execution.

The scope of obfuscation varies depending on programming language or execution environment, but even considering lower levels such as machine code, software obfuscation within a boundary where software may be properly executed is deemed not to have a significant meaning in terms of preventing reverse engineering, etc. Particularly, with regard to the fact that the software must be decrypted right before execution, the scope of software obfuscation can only be narrowed because original software data can be easily achieved by having a third party observe memory state, etc. at the time of executing software.

Thus, in order for effective software obfuscation, the following matters are to be considered.

A. Software existing in a file or memory does not include minimum information required for execution, and this information is restored by both hardware/software platform right before execution.

B. A third party should not be able to access the software restored to achieve minimum information required for execution.

The above aspect may be explained, for example, as applying encryption to a software. When encrypting a software, the software cannot be executed. In order to execute a software, it must be decrypted. In this regard, a third party may observe software decrypted in a memory, etc. However, if it is possible to prevent a third party from observing the decrypted software, it may become possible to implement software obfuscation through encryption.

System for Obfuscating and Restoring a Program Code

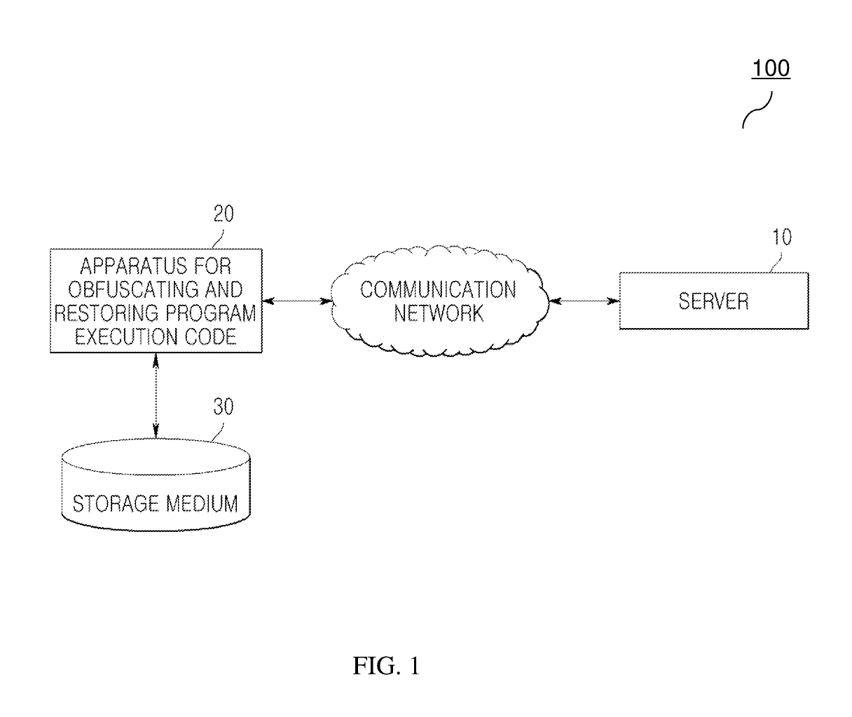

FIG. 1 is a conceptual diagram illustrating a system for obfuscating and restoring a program execution code according to an embodiment of the present invention. Hereinafter, referring to FIG. 1, the constitution of a system for obfuscating and restoring a program execution code according to an embodiment of the present invention is explained in detail.

First, referring to FIG. 1, a system for obfuscating and restoring a program execution code according to an embodiment of the present invention may include a server 10, an apparatus 20 for obfuscating and restoring a program execution code and a storage medium 30.

A server 10 means an end transmitting a program code to an apparatus 20 for obfuscating and restoring a program execution code through a communication network. Here, a communication network includes all means for transmitting a program code, and is not limited to a specific type. It may include wireless networks such as CDMA, TDMA, OFDMA systems, ultra mobile broadband (UMB), IEEE 802.11 (Wi-Fi), IEEE 802.16 (WiMAX), IEEE 802.20, 3GPP long term evolution (LTE), etc., and all wired networks such as local area communication network. Thus, the server 10 may be, for example, a server of an application store providing smartphone applications.

An apparatus 20 for obfuscating and restoring a program execution code may be a general computing device 20. Here, the computing device 20 may include a digital broadcasting terminal, a personal digital assistant (PDA), a smart phone, a tablet PC, an iPad, a 3G, 4G LTE (Long Term Evolution) terminal such as an International Mobile Telecommunication 2000 (IMT-2000) terminal, a Wideband Code Division Multiple Access (WCDMA) terminal, Global System For Mobile Communication Packet Radio Service (GSM/GPRS) and Universal Mobile Telecommunication Service (UMTS) terminal, and all information communication devices and multimedia devices such as GPS, etc. using satellites. Also, a person having ordinary skill in the art may easily understand that the constitution according to an embodiment of the present invention may be applied to a fixed terminal such as a digital TV, a desktop computer, etc., except for the case applied only to mobile terminals.

First, the computing device 20 may obfuscate a program execution code and safely transmit it using a unique random number generator of the device by operating as an apparatus for obfuscating a program execution code according to an embodiment of the present invention.

When a computing device 20 is operated as an apparatus for obfuscating a program execution code, in order to prevent a third party from intercepting a program code while transmitting a program code from a server 10, i.e., a program transmitting end, to a corresponding computing device 20, a program code transmitting end encrypts a program code and transmits it using a public key corresponding to a unique private key of an obfuscating unit of each computing device 20. After decrypting an encrypted program code using its own unique private key, an obfuscating apparatus uses a random number generator to mix the order of a program execution code and stores it in a storage medium.

More specifically, first, a server 10 may encrypt a program code using a public key corresponding to a unique private key granted to each computing device 20. The entire program including an encrypted execution code may be transmitted to each computing device 20.

A computing device 20 receiving program may decrypt the encryption of a program execution code using a unique private key of the corresponding device. Decryption is carried out by an obfuscating unit included in the computing device 20, and other devices such as a CPU or memory, etc. that may be included in the computing device 20 may not intervene therewith. Also, only an obfuscating unit may access the unique private key of the computing device 20.

The obfuscating unit of a computing device 20 may rearrange the execution order of the decrypted program execution code using consecutive random numbers generated using a random number generator again. After inserting a program execution code whose execution order is mixed up into the program again, the obfuscating unit may store the entire program information in a storage medium 30.

Meanwhile, the computing device 20 may operate as an apparatus for restoring an obfuscated program execution code according to an embodiment of the present invention.

By obfuscation mentioned in the above, the order of the program execution code stored in a storage medium 30 such as hard disc, etc. or memory, etc. may be changed by a unique random number of the device, not by its original order, and stored accordingly. When a computing device 20 is operated as an apparatus for restoring an obfuscated program execution code according to an embodiment of the present invention, the order of the obfuscated program code may be restored by an obfuscation restoring unit at the moment of being loaded in the instruction cache (I-cache) of a central processing unit (CPU) upon execution. As far as a third party using a computing device 20 cannot directly observe the I-cache of the CPU, the program code restored to its correct order of execution cannot be known.

Thus, according to a system for obfuscating and restoring a program code according to an embodiment of the present invention, since the execution code order which shows the same operation as the original program execution cannot be known even by a third party who achieved and analyzed a program execution code executed in a single equipment, it is not possible to analyze the algorithm, etc. through program execution code analysis, and it is not possible to execute the achieved execution code at a different equipment. Accordingly, intellectual property right can be protected.

Apparatus for Restoring an Obfuscated Program Execution Code

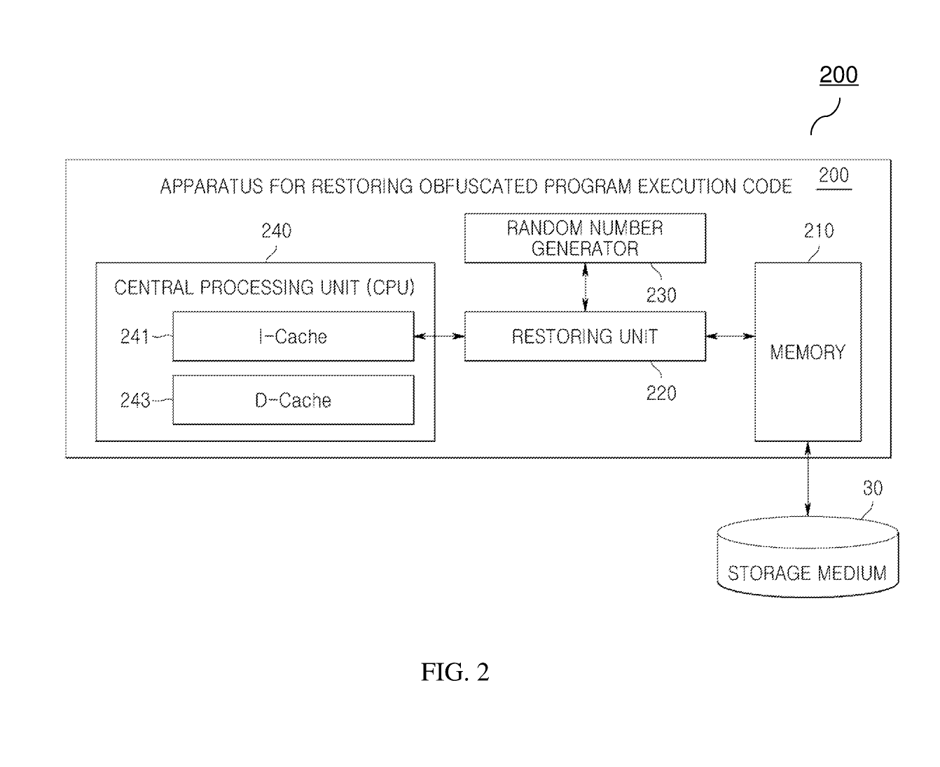

FIG. 2 is a block diagram illustrating a constitution of an apparatus for restoring an obfuscated program execution code according to an embodiment of the present invention. Hereinafter, referring to FIG. 2, an apparatus for restoring an obfuscated program execution code according to an embodiment of the present invention is explained in more detail.

First, as illustrated in FIG. 2, an apparatus 200 for restoring an obfuscated program execution code according to an embodiment of the present invention may include a memory 210 loaded with a program execution code and data, a restoring unit 220 for restoring an obfuscated program code, a random number generator 230 for generating a unique random number required for restoring an obfuscated program code, and a central processing unit (CPU; 240). Also, the CPU 240 may include an instruction cache (I-Cache; 241) storing program execution code and a data cache (D-Cache; 243) storing data.

As described above, in order for more effective software obfuscation, the following matters are to be considered.

A. A third party shall not be able to access software restored to achieve minimum information required for execution.

B. When correcting or accessing hardware in order for a third party to access the software executed, this should be detected and prevented.

In general, as illustrated in FIG. 2, a software is present in the form of a file executable in a storage medium 30 such as a disc, etc. and interpreted by an operating system, etc. as needed and loaded in a memory 210. Then, before being executed by a CPU 240, most of the contents required are loaded as I-cache 241 and D-cache 243. In most operating systems, each process may share a memory, and a user having suitable authority may observe memory image of a desired software since it is an object to be managed. Thus, in order to prevent a third party from accessing software restored to achieve minimum information required for execution, it may be considered to block access to memory 210. However, in this case, the software may not be compatible with the existing operating system, etc. Thus, an apparatus 200 for restoring an obfuscated program execution code according to an embodiment of the present invention may restore a program execution code obfuscated while moving instructions loaded in the memory 210 to I-cache 241.

More specifically, referring to FIG. 2, a memory 210 may load a program execution code obfuscated so as not to be executed before restoration from a storage medium 30. Here, the obfuscated program execution code may be a program execution code rearranging the order of executing instructions included in the original program execution code based on the unique random number sequence for the apparatus 200 for restoring obfuscated program execution code.

The random number generator 230 may generate a unique random number sequence for an apparatus 200 for restoring the obfuscated program execution code. That is, the random number generator 230 may be operated so that each apparatus 200 for restoring a plurality of obfuscated program execution codes generate a column of different random numbers.

The restoring unit 220 does not allow access by a third party who is not a user of the apparatus 200 for restoring the obfuscated program execution code, and may be configured to restore the obfuscated program execution code delivered from the memory 210 and directly transmit it to the central processing unit (CPU). Further, the restoring unit 220 may be configured to restore the obfuscated program execution code by restoring the order of executing the instructions included to its original state by being rearranged in the obfuscated program execution code based on a unique random number sequence generated by a random number generator 230.

Meanwhile, a random number generator 230 and a restoring unit 220 may refer to devices actually generating unique random numbers, etc. for each apparatus and rearranging the order of required instructions through the corresponding contents. For example, they may be included as a physically unclonable function (PUF).

First, the CPU 240 finds a code to be executed by itself according to instructions such as branch statements at an I-cache 241. When there is no code to be executed at the I-cache 241, an appropriate amount of the required code is taken from a software image of the memory 210, and loaded as I-cache 241. In general, it is very difficult to observe the contents of I-cache 241, and a separate hardware device is required. Thus, when obfuscated code image loaded in memory 210 is restored by a restoring unit 220 and directly delivered to an I-cache 241, it would be possible to prevent a third party from figuring out the software code restored through a memory dump, etc.

However, even in this case, when a third party directly observes a bus, etc. between an I-cache 241 and a restoring unit 220, it would be possible to figure out the original code or random number generation properties, etc. of the random number generator 230. In order to be prepared for this aspect, when correcting or accessing hardware in order for a third party to access the software executed, this needs to be detected and prevented.

Thus, a random number generator 230 may be configured so as not to generate a unique random number sequence for the apparatus 200 in response to access by a third party other than a user of an apparatus 200 for restoring an obfuscated program execution code.

Further, the apparatus 200 may further include a housing (not shown) completely surrounding all components included in the apparatus 200, i.e., a memory 210, a restoring unit 220, a random number generator 230, a CPU 240, etc. In this case, in response to damage to the housing, a random number generator 230 may be configured so as not to generate a unique random number sequence for the apparatus 200. Also, when a housing is made of a plurality of parts and there is a joint between the plurality of parts, the random number generator 330 may be configured so as to be physically damaged permanently when the joint of the housing is open by physically being strongly combined with the joint of the housing.

Basically, when the apparatus 200 for restoring an obfuscated program execution code in FIG. 2 performs its function correctly without being modified or damaged, if the code existing in a restoring unit 220 or I-cache 241 as hardware restored to its original state cannot be observed at all, in order to observe the corresponding contents, the hardware needs to be damaged or modified. In this regard, a random number generator 230 may be configured so as not to operate permanently by detecting damage or change to housing, etc. For example, a correct random number generated by a random number generator 230 is required for restoring software obfuscation. However, when a hardware case, i.e., housing is opened, the corresponding random number generating device is damaged and it is not possible to generate the same random number as before. In this case, not only the software in memory 210, etc., but also software code stored in storage medium 30 cannot be reused.

As a result, in order to normally execute an obfuscated software, a restoring unit 220 existing between a memory 210 and I-cache 241 of CPU 240 is required, and when the restoring unit 220 or random number generator 230 is damaged, all software codes stored in the corresponding system cannot be restored permanently.

Hereinafter, an apparatus for obfuscating a program execution code that may recognize and support the corresponding obfuscating restoring apparatus required for generating such software code is explained.

Apparatus for Obfuscating a Program Execution Code

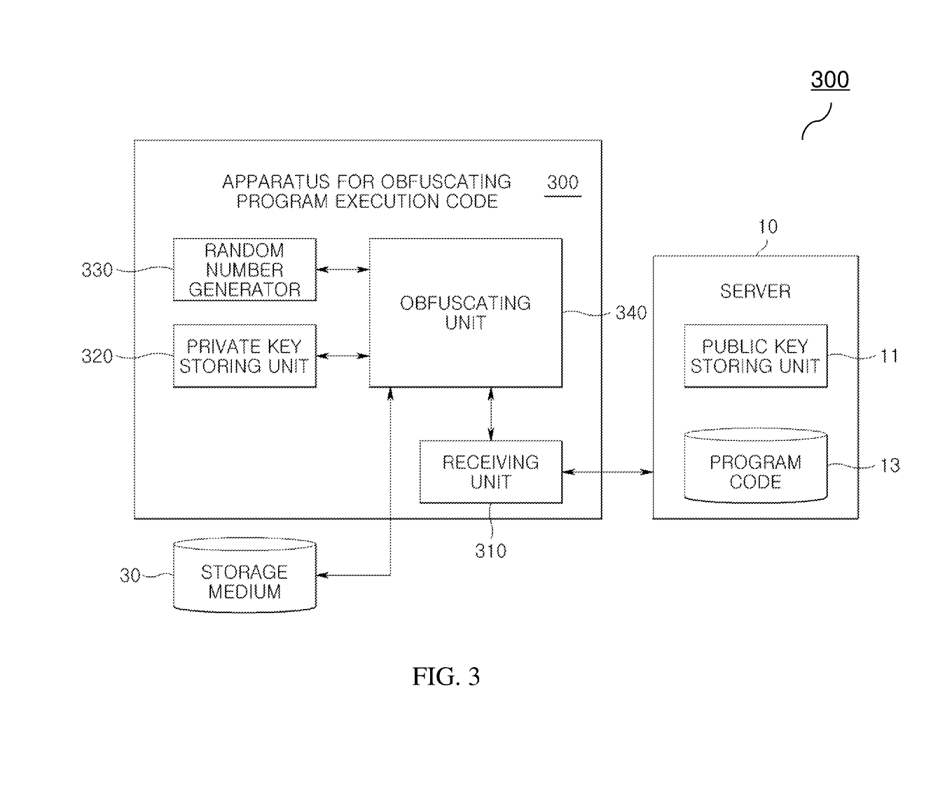

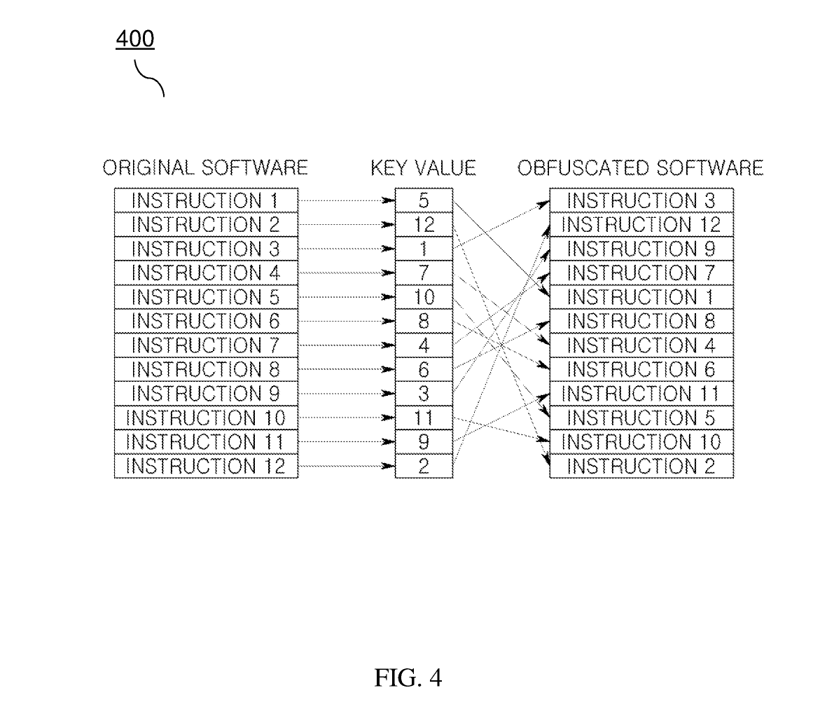

FIG. 3 is a block diagram illustrating a constitution of an apparatus for obfuscating a program execution code according to an embodiment of the present invention. FIG. 4 is an exemplary diagram illustrating software code obfuscation through an obfuscation platform according to an embodiment of the present invention. Hereinafter, referring to FIGS. 3 to 4, the constitution of an apparatus for obfuscating a program execution code according to an embodiment of the present invention is explained in more detail.

Software may be classified into codes to be basically executed and data area used for executing codes. In particular, among the above, software obfuscation focuses on making it difficult to read and analyze codes required for execution (instructions). Particularly, in order to support a platform for an apparatus 200 for restoring an obfuscated program execution code according to an embodiment of the present invention mentioned in the above, the software code is not simply made difficult to be recognized, but the execution order needs to be mixed up to coincide with each apparatus 200 for restoring each obfuscated program execution code.

Hereinafter, referring to FIG. 4, obfuscation of a program execution code according to an embodiment of the present invention is explained as an example.

All software codes are configured as a group of instructions that may be interpreted and processed by CPU. Unless there is a change in execution flow such as conditioned branch statement, etc., the instructions are interpreted and executed in order. It is not possible to determine the direct or indirect causal relation of instructions with software code alone, and in general, the instructions are executed in order until they meet a (conditioned) branch statement. The software obfuscation technique explained herein uses this point to rearrange the order of software instructions through a key (unique random number sequence) generated by a random number generator 330 and arrange the order of instructions to its original state using the same key (unique random number sequence) right before execution. That is, a software code stored in a storage medium 30 such as disc, etc. or memory (not shown) has a form existing on the right of the key (unique random number sequence) in FIG. 4, and the instructions loaded in the I-cache 241 after going through the restoring unit 220 of obfuscation may have the form on the left of the key (unique random number sequence) in FIG. 4.

The apparatus 300 for obfuscating a program execution code according to an embodiment of the present invention may use any one of the following two methods in order to generate a software code that may be restored by an apparatus 200 for restoring an obfuscated program execution code according to an embodiment of the present invention.

A. A platform generating obfuscation code has the same number of random number generators as the subject apparatus.

B. A platform generating obfuscation code generates an encryption code that may be used in the same manner for all apparatuses, and each apparatus obfuscates the code by itself through its own random number generator after solving the encryption code, and stores the code.

As for method A, there is an advantage that the code cannot be used for apparatuses other than the corresponding apparatus even if the code is revealed in the middle, but there are limitations in use when the same random number generator cannot be made as the PUF mentioned above. As for method B, there is a possibility for the code to be revealed in the middle, but there is an advantage that a unique random number generator may be used for each apparatus.

Meanwhile, referring to FIG. 3, the constitution of the apparatus 300 for obfuscating a program execution code according to an embodiment of the present invention is explained in more detail. First, a server 10 may encrypt a program code 13 using a public key corresponding to a unique private key granted to each apparatus 300 for obfuscating each program execution code. The public key may be obtained from a public key storing unit 11 included in the server 10.

Then, the entire program including the encrypted execution code may transmit a program execution code to an apparatus 300 for obfuscating. That is, a receiving unit 310 may receive an encryption program execution code encrypted based on a public key corresponding to a unique private key of the apparatus 300 from a server 10.

A private key storing unit 320 may store a unique private key for the apparatus 300, and an obfuscating unit 340 may be configured to decrypt the encryption program execution code based on the unique private key, obfuscate the decrypted program execution code so as not to be executed before restoration, and store the obfuscated program execution code in a storage medium 30.

Further, a random number generator 330 may generate a unique random number sequence for the apparatus 300, and the obfuscating unit 340 may be configured to generate the obfuscated program execution code by rearranging the order of executing instructions of the decrypted program execution code based on the unique random number sequence for the apparatus 300.

Meanwhile, as mentioned above, decryption is performed by an obfuscating unit 340, and other apparatuses such as a CPU (not shown) or memory (not shown) which may be included in the apparatus 300 for obfuscating the program execution code may not intervene therewith. Also, only an obfuscating unit 340 may obtain a unique private key stored in a private key storing unit 320.

Meanwhile, an apparatus 300 for obfuscating a program execution code according to an embodiment of the present invention may respond by detecting a third party's attempt of access to a random number. More specifically, a random number generator 330 may be configured so as not to generate a unique random number sequence for the apparatus 300 in response to access by a third party other than a user of the apparatus 300 for obfuscating a program execution code.

Moreover, the apparatus 300 may further include a housing (not shown) that may completely surround all components included in the apparatus 300. In this case, a random number generator 330 may be configured so as not to generate a unique random number sequence for the apparatus 300 in response to damage to the housing. Also, when a housing is made of a plurality of parts and there is a joint between the plurality of parts, the random number generator 330 may be configured so as to be physically damaged permanently when the joint of the housing is open by physically being strongly combined with the joint of the housing.

Method for Restoring an Obfuscating Program Execution Code

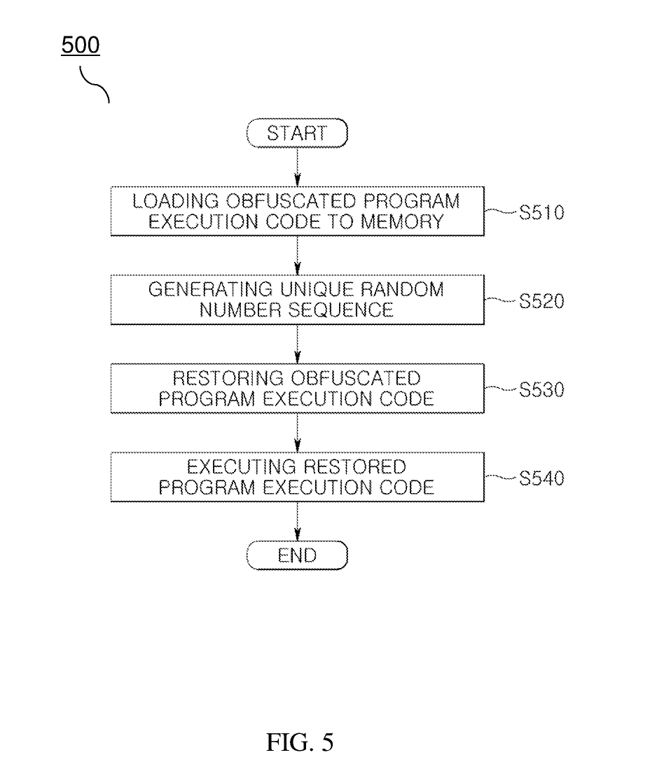

FIG. 5 is a flow chart illustrating a method for restoring an obfuscated program execution code according to an embodiment of the present invention. Hereinafter, referring to FIG. 5, a method for restoring an obfuscated program execution code according to an embodiment of the present invention is explained in more detail. As mentioned with regard to FIG. 1 in the above, the method may be performed by a computing device 20.

As illustrated in FIG. 5, according to a method for restoring an obfuscated program execution code according to an embodiment of the present invention, a program execution code obfuscated so as not to be executed before restoration may be loaded from a storage medium to a memory (S510). Then, a unique random number sequence is generated for the computing device (S520), and restored right before the obfuscated program execution code is delivered to a central processing unit (CPU) so that the restored program execution code is not loaded to the memory (S530). In this regard, the obfuscated program execution code is a program execution code having the order of executing instructions rearranged based on the unique random number sequence. The restoring step (S530) may restore the obfuscated program execution code by restoring the order of executing the instructions to its original state based on the unique random number sequence. Then, the restored program execution code may be executed using a CPU (S540).

Meanwhile, the method may further include a step of interrupting generation of the unique random number sequence in response to access by a third party other than a user of a computing device, and the interrupting step may interrupt generation of the unique random number sequence in response to damage to the housing completely surrounding the computing device.

In the above, a method for restoring an obfuscated program execution code according to an embodiment of the present invention was explained. As a more detailed embodiment, the method may perform a step of conforming to the operation of an apparatus for restoring an obfuscated program execution code according to an embodiment of the present invention.

Method for Obfuscating a Program Execution Code

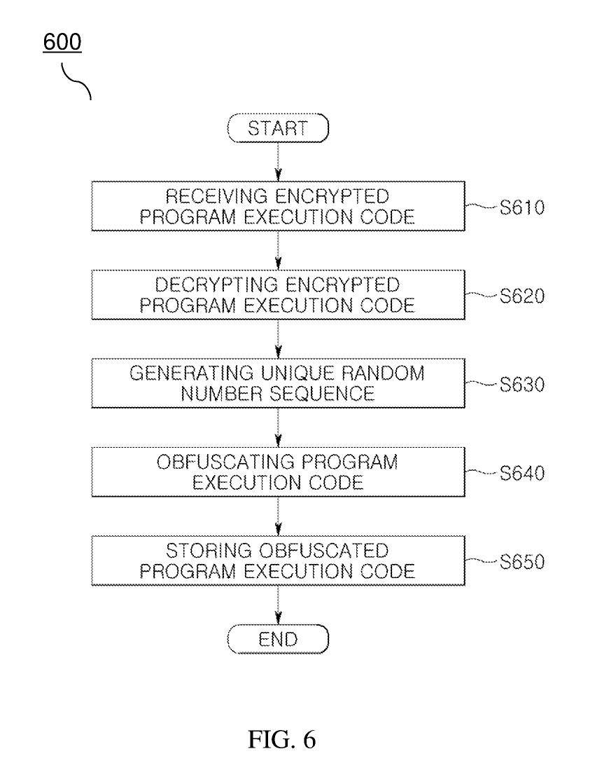

FIG. 6 is a flow chart illustrating a method for obfuscating a program execution code according to an embodiment of the present invention. Hereinafter, referring to FIG. 6, a method for obfuscating a program execution code according to an embodiment of the present invention is explained in more detail. As mentioned with regard to FIG. 1 in the above, the method may be performed by a computing device 20.

As illustrated in FIG. 6, according to a method for obfuscating a program execution code according to an embodiment of the present invention, an encryption program execution code encrypted based on a public key corresponding to a unique private key of a computing device may be received from a server (S610), and the encryption program execution code may be decrypted based on a unique private key of the computing device (S620). Then, a unique random number sequence for a computing device may be generated (S630), to obfuscate it so as not to be executed before restoring the decrypted program execution code (S640). Here, the obfuscating step (S640) may generate the obfuscated program execution code by rearranging the order of executing instructions of the decrypted program execution code based on the unique random number sequence. Then, the obfuscated program execution code may be stored in a storage medium (S650).

Meanwhile, the method may further include a step of interrupting generation of the unique random number sequence in response to access by a third party other than a user of a computing device, and the interrupting step may interrupt generation of the unique random number sequence in response to damage to the housing completely surrounding the computing device.

In the above, a method for obfuscating a program execution code according to an embodiment of the present invention is explained. As a more detailed embodiment, the method may perform a step of conforming to the operation of an apparatus for obfuscating a program execution code according to an embodiment of the present invention.

Although the exemplary embodiments of the present invention have been described, it is understood that the present invention should not be limited to these exemplary embodiments but various changes and modifications can be made by a person ordinarily skilled in the art within the idea and scope of the present invention as hereinafter claimed.

What is claimed is:

1. An apparatus for restoring an obfuscated program execution code, comprising:
a memory loading a program execution code obfuscated so as not to be executed before restoration from a storage medium;
a restoring unit, not allowing access by a third party who is not a user of the apparatus, restoring the obfuscated program execution code delivered from the memory and directly delivering it to a central processing unit (CPU); and
a CPU executing the restored program execution code.

2. The apparatus of claim 1, further comprising:
a random number generator generating a unique random number sequence for the apparatus,
wherein the obfuscated program execution code is a program execution code rearranging the order of executing instructions based on the unique random number sequence for the apparatus, and
the restoring unit restores the obfuscated program execution code by restoring the order of executing the instructions to its original state based on the unique random number sequence for the apparatus.

3. The apparatus of claim 1, wherein
the CPU comprises an instruction cache (I-cache) and a data cache (D-cache), and
the restoring unit directly delivers the restored program execution code to the I-cache.

4. The apparatus of claim 2, wherein
the random number generator is configured so as not to generate a unique random number sequence for the apparatus in response to access by a third party other than a user of the apparatus.

5. The apparatus of claim 4, further comprising:
a housing completely surrounding the apparatus,
wherein the random number generator is configured so as not to generate a unique random number sequence for the apparatus in response to damage to the housing.

6. The apparatus of claim 5, wherein
the random number generator is physically combined with a joint of the housing and configured to be permanently damaged when the housing is open.

7. An apparatus for obfuscating a program execution code, comprising:
a receiving unit for receiving an encryption program execution code encrypted based on a public key corresponding to a unique private key of the apparatus;
a private key storing unit for storing the unique private key of the apparatus; and
an obfuscating unit for decrypting the encryption program execution code based on the unique private key, obfuscating the decrypted program execution code so that it is not executed before restoration, and storing the obfuscated program execution code in a storage medium.

8. The apparatus of claim 7, further comprising:
a random number generator generating a unique random number sequence for the apparatus,
wherein the obfuscating unit generates the obfuscated program execution code by rearranging the order of executing instructions of the decrypted program execution code based on the unique random number sequence for the apparatus.

9. The apparatus of claim 8, wherein
the random number generator is configured so as not to generate a unique random number sequence for the apparatus in response to access by a third party other than a user of the apparatus.

10. The apparatus of claim 9, further comprising:
a housing completely surrounding the apparatus,
wherein the random number generator is configured so as not to generate a unique random number sequence for the apparatus in response to damage to the housing.

11. The apparatus of claim 10, wherein
the random number generator is physically combined with a joint of the housing and configured to be permanently damaged when the housing is open.

12. A method for restoring an obfuscated program execution code performed by a computing device, the method comprising:
loading a program execution code obfuscated so as not to be executed before restoration from a storage medium to a memory;
restoring the obfuscated program execution code right before delivering it to a central processing unit (CPU) so that the restored program execution code is not loaded in the memory; and
executing the restored program execution code by using the CPU.

13. The method of claim 12, further comprising:
generating a unique random number sequence for the computing device,
wherein the obfuscated program execution code is a program execution code rearranging the order of executing instructions based on the unique random number sequence, and
the restoring step restores the obfuscated program execution code by restoring the order of executing the instructions to its original state based on the unique random number sequence.

14. The method of claim 13, further comprising:
interrupting generation of the unique random number sequence in response to access by a third party other than a user of the computing device.

15. The method of claim 14, wherein
the interrupting step interrupts generation of the unique random number sequence in response to damage to a housing completely surrounding the computing device.

16. A method for obfuscating a program execution code performed by a computing device, the method comprising:
receiving an encryption program execution code encrypted based on a public key corresponding to a unique private key of the computing device from a server;
decrypting the encryption program execution code based on a unique private key of the computing device;
obfuscating the decrypted program execution code so that it is not executed before restoration; and
storing the obfuscated program execution code in a storage medium.

17. The method of claim 16, further comprising:
generating a unique random number sequence for the computing device,
wherein the obfuscating step generates the obfuscated program execution code by rearranging the order of instructions of the decrypted program execution code based on the unique random number sequence.

18. The method of claim 17, further comprising:
interrupting generation of the unique random number sequence in response to access by a third party other than a user of the computing device.

19. The method of claim 18, wherein
the interrupting step interrupts generation of the unique random number sequence in response to damage to a housing completely surrounding the computing device.
